(19) United States
(12) Patent Application Publication
(10) Pub. No.: US 2021/0182572 A1
(43) Pub. Date: Jun. 17, 2021

(54) DRIVE RECORDER AND IMAGE STORAGE SYSTEM

(71) Applicant: DENSO CORPORATION, Kariya-city (JP)

(72) Inventor: Yasunori KANNO, Kariya-city (JP)

(21) Appl. No.: 17/183,624

(22) Filed: Feb. 24, 2021

Related U.S. Application Data
(63) Continuation of application No. PCT/JP2019/026940, filed on Jul. 8, 2019.

(30) Foreign Application Priority Data
Sep. 26, 2018 (JP) 2018-180371

(51) Int. Cl. G06K 9/00; G06K 9/62; B60W 50/14

(52) U.S. Cl. CPC G06K 9/00791; B60W 2050/146; B60W 50/14; G06K 9/6276

(57) ABSTRACT

A drive recorder includes: an image generation unit that captures a periphery of the vehicle, and generates an image; a capture image storage unit that stores the image; a danger pattern classification unit that associates the image with any of multiple danger patterns; an information transmission unit that transmits vehicle information including a danger pattern associated with the image and identification information of the vehicle to the management apparatus; an instruction acquisition unit that acquires a transmission instruction specifying the danger pattern from the management apparatus; and an image transmission unit that transmits the image to the management apparatus.

### CROSS REFERENCE TO RELATED APPLICATIONS

The present application is a continuation application of International Patent Application No. PCT/JP2019/026940 filed on Jul. 8, 2019, which designated the U.S. and claims the benefit of priority from Japanese Patent Application No. 2018-180371 filed on Sep. 26, 2018. The entire disclosures of all of the above applications are incorporated herein by reference.

### TECHNICAL FIELD

The present disclosure relates to a drive recorder and an image storage system.

### BACKGROUND

The drive recorder captures a periphery of a vehicle, generates an image, and stores the image. As a comparative example, the following technology for a drive recorder has been proposed. A removable storage medium is attached to the drive recorder. While the vehicle travels, an image is stored in this storage medium. After the vehicle has finished traveling, the storage medium is removed from the drive recorder, and is inserted into a computer in an office. The image stored in the storage medium is read by the computer in the office.

### SUMMARY

A drive recorder may include: an image generation unit that may capture a periphery of the vehicle, and generate an image; a capture image storage unit that may store the image; a danger pattern classification unit that may associate the image with any of multiple danger patterns; an information transmission unit that may transmit vehicle information including a danger pattern associated with the image and identification information of the vehicle to the management apparatus; an instruction acquisition unit that may acquire a transmission instruction specifying the danger pattern from the management apparatus; and an image transmission unit that may transmit the image to the management apparatus.

### BRIEF DESCRIPTION OF DRAWINGS

The above and other objects, features and advantages of the present disclosure will be more clearly understood from the following detailed description with reference to the accompanying drawings. In the accompanying drawings,

FIG. 1 is a block diagram showing a configuration of an image storage system;

FIG. 2 is a block diagram showing a functional configuration of a controller;

FIG. 3 is a block diagram showing a functional configuration of the controller;

FIG. 4 is a flowchart showing processes executed by a drive recorder; and

FIG. 5 is a flowchart showing processes executed by a management apparatus.

### DETAILED DESCRIPTION

It is considered that an image stored by a drive recorder is transmitted to an external device via communication. In this case, when all of the images stored by the drive recorder are transmitted, the amount of data of the transmitted images becomes large. A communication charge for transmitting the images becomes high.

One example of the present disclosure provides a drive recorder and an image storage system capable of suppressing a data amount of an image storage system transmitted from the drive recorder to a management apparatus and suppressing a communication charge when transmitting the image.

According to one example embodiment, a drive recorder is mounted on a vehicle, and communicates a management apparatus. The drive recorder includes: an image generation unit that captures a periphery of the vehicle, and generates an image; a capture image storage unit that stores the image generated by the image generation unit; a danger pattern classification unit that associates the image with any of multiple danger patterns set in advance by analyzing the image generated by the image generation unit; an information transmission unit that transmits vehicle information including a danger pattern associated with the image and identification information of the vehicle to the management apparatus; an instruction acquisition unit that acquires a transmission instruction specifying the danger pattern from the management apparatus; and an image transmission unit that transmits the image that is stored in the capture image storage unit and is associated with the danger pattern specified by the transmission instruction to the management apparatus.

According to another example embodiment, the drive recorder transmits the image associated with the danger pattern specified by the transmission instruction to the management apparatus. Therefore, according to one aspect of the present disclosure, the drive recorder may not necessarily transmit all of the images stored in the drive recorder to the management apparatus. As the result, according to one aspect of the present disclosure, it may be possible to suppress the data amount of the image transmitted from the drive recorder to the management apparatus and the communication charge when transmitting the image.

According to another example embodiment, the image storage system includes a drive recorder and a management apparatus. The management apparatus includes: a vehicle information storage unit that stores the vehicle information transmitted by the information transmission unit; an instruction transmission unit that transmits the transmission instruction; and a reception image storage unit that stores the image transmitted by the image transmission unit.

Exemplary Embodiments of the Present Disclosure Will be Described with Reference to the Drawings.

### First Embodiment

1. Configuration of Image Storage System

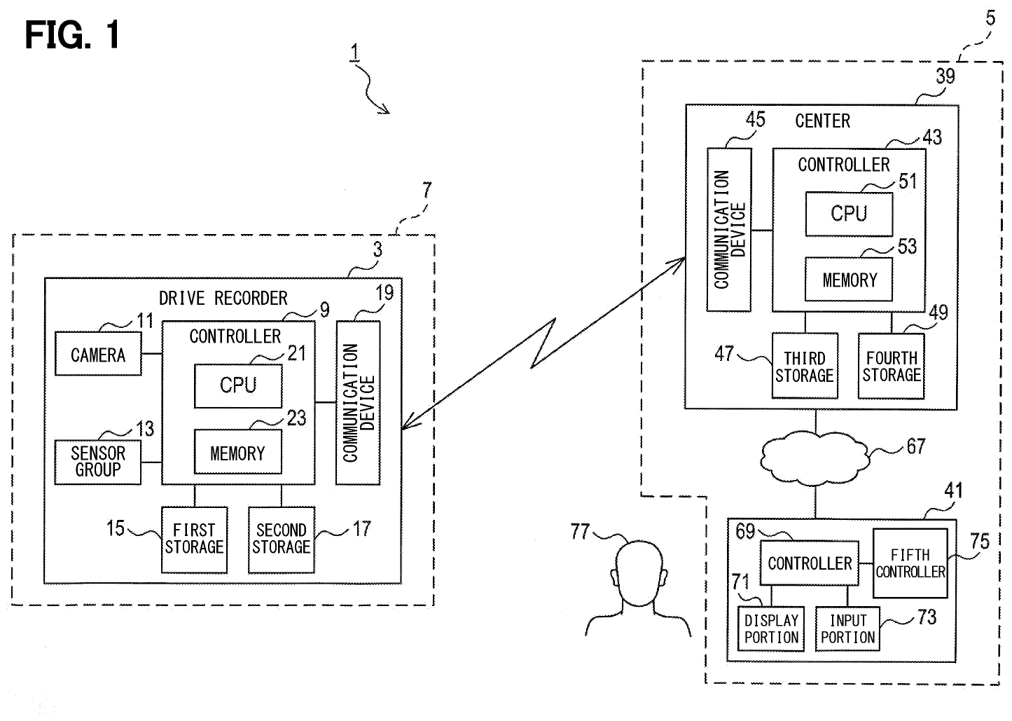

A configuration of an image storage system 1 will be described with reference to FIGS. 1 to 3. As shown in FIG. 1, the image storage system 1 includes a drive recorder 3 and a management apparatus 5. Although the image storage system 1 includes multiple drive recorders 3, only one drive recorder 3 is shown in FIG. 1 for convenience. The multiple drive recorders 3 include the similar configurations, and execute the similar processes. The management apparatus 5 executes the similar process for the multiple drive recorders 3.

(1) Configuration of Drive Recorder

The drive recorder 3 is mounted on a vehicle 7. The drive recorder 3 can communicate with the management apparatus 5 by using a communication device 19 described later.

The drive recorder 3 includes a controller 9, a camera 11, a sensor group 13, a first storage 15, a second storage 17, and the communication device 19.

The controller 9 includes a microcomputer having a CPU 21 and a semiconductor memory (hereinafter, a memory 23) such as a RAM or a ROM, for example. Functions provided by the controller 9 are implemented by the CPU 21 executing a program stored in the non-transitory tangible storage medium. In this example, the memory 23 corresponds to the non-transitory tangible storage medium storing the program. Further, by executing this program, a method corresponding to the program is executed. The controller 9 may include one or more microcomputers.

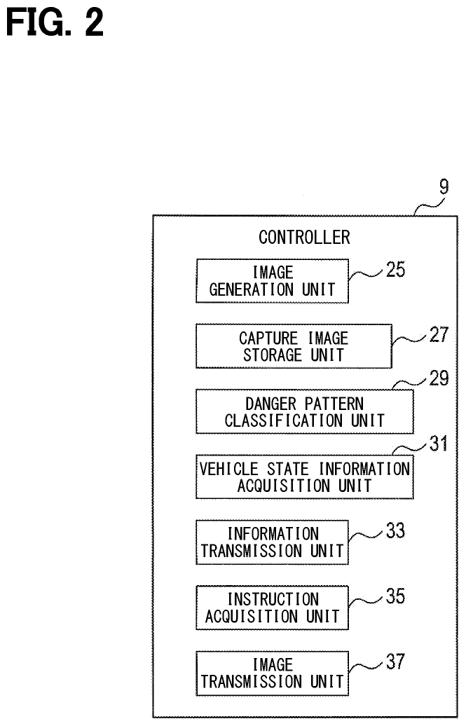

As shown in FIG. 2, the controller 9 includes an image generation unit 25, a capture image storage unit 27, a danger pattern classification unit 29, a vehicle state information acquisition unit 31, an information transmission unit 33, an information acquisition unit 35, and an image transmission unit 37.

The method of implementing the functions of the respective units included in the controller 9 is not limited to software, and a part or all of the functions thereof may be implemented by using one or multiple hardware circuits. For example, when the above-described functions may be implemented by an electronic circuit which is hardware, the electronic circuit may be implemented by a digital circuit, an analog circuit, or a combination thereof.

The camera 11 captures a periphery of the vehicle 7, and generates the image. The periphery of the vehicle 7 is, for example, the front of the vehicle 7, the rear, or the side. The generated image is, for example, a movie of which capture time has a predetermined length.

The sensor group 13 is a group of sensors that acquire vehicle state information. The vehicle state information is information representing a state of the vehicle 7. The vehicle state information is, for example, information representing a position of the vehicle 7, a vehicle speed of the vehicle 7, a G value of the vehicle 7, a date and a time point when the vehicle state information is acquired, or the like.

The first storage 15 can store the image generated by the camera 11. The second storage 17 can store the vehicle state information acquired by the sensor group 13. The communication device 19 can communication device 19 with a communication device 45 that is included in the management apparatus 5 and described later.

(2) Configuration of Management Apparatus

The management apparatus 5 includes a center 39 and a terminal 41. The center 39 is fixedly installed outside the vehicle 7. The center 39 includes a controller 43, the communication device 45, a third storage 47, and a fourth storage 49.

The controller 43 includes a microcomputer having a CPU 51 and a semiconductor memory (hereinafter, a memory 53) such as a RAM or a ROM, for example. Functions provided by the controller 43 are implemented by the CPU 51 executing a program stored in the non-transitory tangible storage medium. In this example, the memory 53 corresponds to the non-transitory tangible storage medium storing the program. Further, by executing this program, a method corresponding to the program is executed. The controller 43 may include one or more microcomputers.

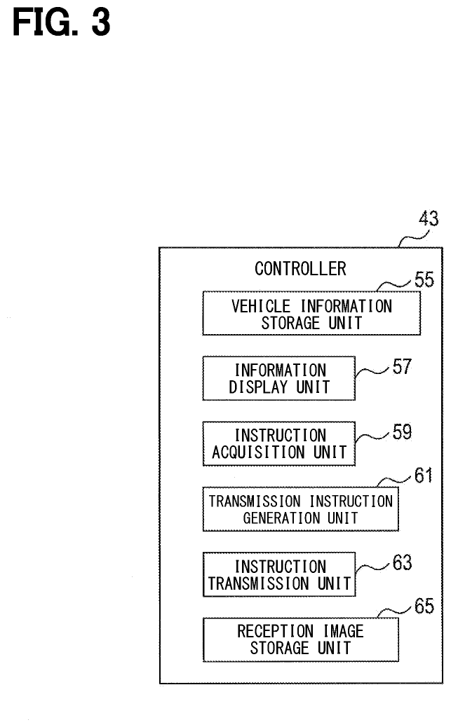

As shown in FIG. 3, the controller 43 includes a vehicle information storage unit 55, an information display unit 57, an instruction acquisition unit 59, a transmission instruction generation unit 61, an instruction transmission unit 63, and a reception image storage unit 65.

The method of implementing the functions of the respective units included in the controller 43 is not limited to software, and a part or all of the functions thereof may be implemented by using one or a plurality of hardware circuits. For example, when the above-described functions may be implemented by an electronic circuit which is hardware, the electronic circuit may be implemented by a digital circuit, an analog circuit, or a combination thereof.

The communication device 45 can communicate with the communication device 19. The third storage 47 can storage vehicle information that is transmitted from the drive recorder 3 and described later. The fourth storage 49 can store the image transmitted from the drive recorder 3.

The terminal 41 is placed outside the vehicle 7. The terminal 41 is placed at, for example, a position away from the center 39. The terminal 41 can communicate with the center 39 via an internet network 67. The terminal 41 includes a controller 69, a display portion 71, an input portion 73, and a fifth storage 75.

The controller 69 includes a microcomputer. An operation management application is installed in the controller 69. The controller 69 executes a process described later in accordance with the operation management application.

The display portion 71 is a display capable displaying information. The operator 77 can visually recognize the information displayed by the display portion 71. The input portion 73 receives an input operation by the operator 77. The input portion 73 is, for example, a keyboard, a touch panel, various switches, or the like. The fifth storage 75 can store the image or the like.

2. Processes Executed by Drive Recorder

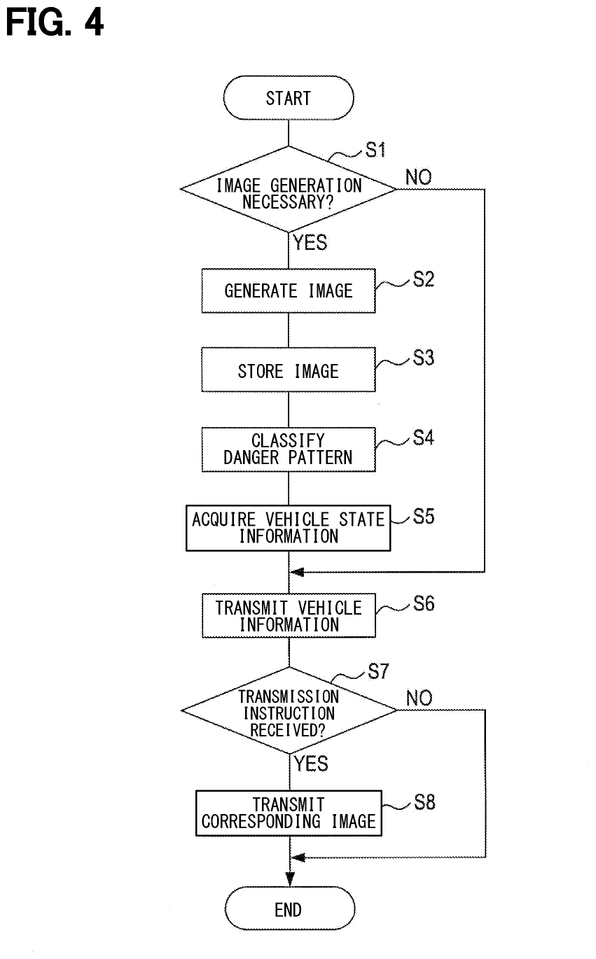

Processes repeatedly executed by the drive recorder 3 at predetermined time intervals will be described with reference to FIG. 4. In S1 of FIG. 4, the image generation unit 25 determines whether it is necessary to generate the image. The case where it is necessary to generate the image includes, for example, a case where the G value detected by the sensor group 13 exceeds a predetermined threshold value, or the like. When it is determined that the image generation is necessary, the current process shifts to S2. When it is determined the image generation is not necessary, the current process shifts to S7.

In S2, the image generation unit 25 generates the image by using the camera 11. The generated image is a movie obtained by capturing the periphery of the vehicle 7 for a predetermined time.

In S3, the capture image storage unit 27 stores the image generated in S2 in the first storage 15.

In S4, the danger pattern classification unit 29 analyzes the image stored in the immediately preceding S3, and thereby associates the analyzed image with any of multiple danger patterns set in advance. This process will be specifically described below.

The analysis of the image is, for example, a process of recognizing things such as different vehicles, pedestrians, traffic lights, intersections, or traffic signs in then image, and estimating a position of each of the recognized things, a moving direction of each of the recognized things, a movement speed of each of the recognized things, or the like.

The drive recorder 3 stores the multiple danger patterns in advance. The danger pattern is, for example, a danger pattern in which the pedestrian runs out into the front of the vehicle 7, a danger pattern in which a preceding vehicle suddenly brakes, or the like.

The danger pattern classification unit 29 compares the analysis result of the image with each of the multiple danger patterns, and selects the danger pattern that most closely matches the analysis result of the image. The danger pattern classification unit 29 associates the selected danger pattern with the image stored in the immediately preceding S3. In other words, the danger pattern classification unit 29 classifies the danger pattern based on the image.

In S5, the vehicle state information acquisition unit 31 acquires the vehicle state information by using the sensor group 13.

In S6, the information transmission unit 33 transmits the vehicle information to the center 39 by using the communication device 19. The vehicle information is information including the danger pattern associated with the image in S4, the vehicle state information acquired in S5, and the identification information of the vehicle 7.

In S7, the information acquisition unit 35 determines whether the communication device 19 receives a transmission instruction. The transmission instruction is an instruction transmitted by the center 39 in S16 described later. When the center 39 has transmitted the transmission instruction, the communication device 19 receives the transmission instruction. The information acquisition unit 35 acquires the transmission instruction received by the communication device 19. When the communication device 19 has received the transmission instruction, the current process shifts to S8. When the communication device 19 has not received the transmission instruction, the current process ends.

In S8, the image transmission unit 37 reads the image from the first storage 15. The read image is the image associated with the danger pattern specified by the transmission instruction determined to have been received in S7. When the transmission instruction includes an instruction other than the danger pattern, the read image is an image associated with the danger pattern specified by the transmission instruction and matches a designation other than the danger pattern.

Further, the image transmission unit 37 transmits the read image and the identification information of the vehicle 7 to the center 39 by using the communication device 19.

3. Processes Executed by Management Apparatus

(1) First Process

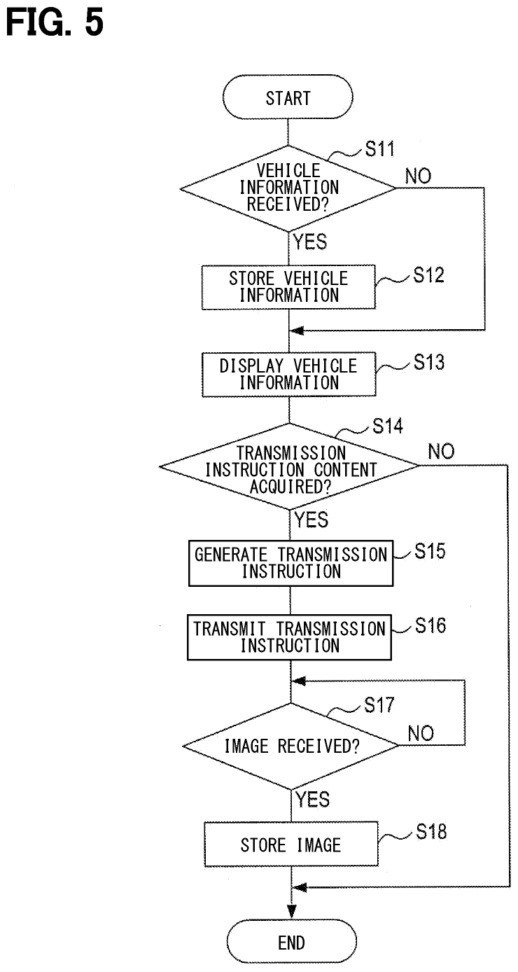

Processes repeatedly executed by the management apparatus 5 at predetermined time intervals will be described with reference to FIG. 5. In S11 of FIG. 5, the vehicle information storage unit 55 determines whether the communication device 45 has received the vehicle information. The vehicle information is information transmitted by the drive recorder 3 in S6. When the vehicle information has been received, the current process shifts to S12. When the vehicle information has not been received, the current process shifts to S13.

In S12, the vehicle information storage unit 55 stores the vehicle information determined to have been received in S11 in the third storage 47.

In S13, the information display unit 57 causes the display portion 71 of the terminal 41 to display the vehicle information stored in the third storage 47. The controller 69 of the terminal 41 executes a process of displaying the vehicle information transmitted from the center 39 on the display portion 71.

Then, the operator 77 can determine the content of the transmission instruction by looking at the vehicle information displayed on the display portion 71. The transmission instruction content includes the instruction of the danger pattern or the like. The transmission instruction content may include, for example, an instruction other than the danger pattern. The instruction other than the danger pattern is, for example, a vehicle designation, a vehicle position designation, a designation of a time when the image is generated, or the like. The operator can input the content of the determined transmission instruction to the input portion 73. The controller 69 of the terminal 41 transmits the transmission instruction input to the input portion 73 to the center 39.

In S14, the instruction acquisition unit 59 determines whether the instruction acquisition unit 59 has acquired the transmission instruction content. When the operator 77 has input the transmission instruction content to the input portion 73, the instruction acquisition unit 59 has acquired the transmission instruction content. When the operator 77 has not input the transmission instruction content to the input portion 73, the instruction acquisition unit 59 has not acquired the transmission instruction content. When the instruction acquisition unit 59 has acquired the transmission instruction content, the current process shifts to S15. When the instruction acquisition unit 59 has not acquired the transmission instruction content, the current process ends.

In S15, the transmission instruction generation unit 61 generates the transmission instruction based on the transmission instruction content determined to have been acquired in S14. The transmission instruction includes a designation of at least the danger pattern. When the transmission instruction content includes a designation other than the danger pattern, the transmission instruction includes the designation other than the danger pattern.

In S16, the instruction transmission unit 63 transmits the transmission instruction generated in S15 to the drive recorder 3 by using the communication device 45.

In S17, the reception image storage unit 65 determines whether the communication device 45 has received the image. The image is an image transmitted by the drive recorder 3 in S8. When the communication device 45 has received the image, the reception image storage unit 65 acquires the image. When the communication device 45 has received the image, the current process shifts to S18. When the communication device 45 has not received the image, the current process returns to the process before S17.

In S18, the reception image storage unit 65 stores the image determined to have been received in S17 in the fourth storage 49. The reception image storage unit 65 stores the identification information of the vehicle 7 in the fourth storage 49 in association with the image.

The center 39 and the terminal 41 can display the image stored in the fourth storage 49 on the display portion 71. The operator 77 can see the image displayed on the display portion 71.

(2) Second Process

The operator 77 can input a download request of the image to the input portion 73. The download request includes, for example, a designation of a range of the image to be download. The controller 69 transmits the download request to the center 39.

The controller 43 receives the download request. The controller 43 reads the image specified by the download request from the fourth storage 49, and transmits the image to the terminal 41. After transmitting the image, the controller 43 deletes the transmitted image in the fourth storage 49. The controller 69 receives the image from the center 39, and stores the image in the fifth storage 75.

4. Effects Implemented by Image Storage System and Drive Recorder

(1A) The drive recorder 3 transmits the image associated with the danger pattern specified by the transmission instruction to the center 39. Therefore, the drive recorder 3 may not necessarily transmit all of the images stored in the first storage 15 to the center 39. As the result, it may be possible to suppress the data amount of the image transmitted from the drive recorder 3 to the center 39 and the communication charge when transmitting the image.

(1B) The center 39 transmits the transmission instruction to the drive recorder 3. The drive recorder 3 transmits the image corresponding to the transmission instruction content to the center 39. Therefore, the center 39 can store the highly necessary image.

(1C) The management apparatus 5 displays the vehicle information on the display portion 71. The operator 77 can determine the content of the transmission instruction by looking at the vehicle information displayed on the display portion 71, and input the transmission instruction content to the input portion 73. The center 39 acquires the transmission instruction content input to the input portion 73. The center 39 generates the transmission instruction based on the acquired transmission instruction content. Therefore, the center 39 can instruct the drive recorder 3 to transmit the highly necessary image.

(1D) The drive recorder 3 adds the vehicle state information to the vehicle information. The management apparatus 5 displays the vehicle information including the vehicle state information on the display portion 71. The operator 77 can determine the transmission instruction content in consideration of the vehicle state information.

(1E) The management apparatus 5 downloads the image stored in the fourth storage 49, and can store the image in the fifth storage 75. The management apparatus 5 can delete the downloaded image in the fourth storage 49. As the result, the management apparatus 5 can suppress the capacity of the fourth storage 49.

### Other Embodiments

Although the embodiment of the present disclosure has been described above, the present disclosure is not limited to the embodiment described above, and various modifications can be made to implement the present disclosure.

(1) The controller 43 may determine the transmission instruction content based on the vehicle information stored in the third storage 47.

(2) Multiple functions of one element in the above embodiments may be implemented by multiple elements, or one function of one element may be implemented by multiple elements. In addition, multiple functions of multiple components may be implemented by one component, or a single function implemented by multiple components may be implemented by one component. In addition, a part of the configuration of the above embodiment may be omitted. Further, at least part of the configuration of the above-described embodiment may be added to or replaced with the configuration of another embodiment described above.

(3) In addition to the drive recorder described above and the image storage system, the present disclosure can be implemented by various forms such as a system including the drive recorder as the component, a program causing a computer to function as the drive recorder or the management apparatus, a non-transitory tangible storage medium such as a semiconductor memory storing this program, an image storing method, or an image transmission method.

It is noted that a flowchart or the process of the flowchart in the present disclosure includes multiple steps (also referred to as sections), each of which is represented, for instance, as S1. Further, each step can be divided into several sub-steps while several steps can be combined into a single step.

1. A drive recorder that is mounted on a vehicle and is configured to communicate with a management apparatus, the drive recorder comprising:
an image generation unit configured to capture a periphery of the vehicle, and generate an image;
a capture image storage unit configured to store the image generated by the image generation unit;
a danger pattern classification unit configured to associate the image with any of a plurality of danger patterns set in advance by analyzing the image generated by the image generation unit;
an information transmission unit configured to transmit vehicle information including
a danger pattern associated with the image and
identification information of the vehicle to the management apparatus;
an instruction acquisition unit configured to acquire a transmission instruction specifying the danger pattern from the management apparatus; and
an image transmission unit configured to transmit the image that is stored in the capture image storage unit and is associated with the danger pattern specified by the transmission instruction to the management apparatus.

2. The drive recorder according to claim 1, further comprising:
a vehicle state information acquisition unit configured to acquire vehicle state information representing a state of the vehicle
wherein:
the vehicle information further includes the vehicle state information.

3. An image storage system comprising:
the drive recorder according to claim 1; and
the management apparatus,
wherein:
the management apparatus includes:
a vehicle information storage unit configured to store the vehicle information transmitted by the information transmission unit;
an instruction transmission unit configured to transmit the transmission instruction; and
a reception image storage unit configured to store the image transmitted by the image transmission unit.

4. The image storage system according to claim 3, wherein:
the management apparatus further includes:
an information display unit configured to display the vehicle information;
an instruction acquisition unit configured to acquire a transmission instruction content; and
a transmission instruction generation unit configured to generate the transmission instruction based on the transmission instruction content acquired by the instruction acquisition unit.

5. The drive recorder according to claim 1, wherein:
the danger pattern includes
a danger pattern in which a pedestrian or a bicycle runs out into a front of the vehicle,
a danger pattern in which a preceding vehicle suddenly stops,
a danger pattern in which an oncoming vehicle goes across a center lane marking and comes in front of the vehicle, or
a danger pattern in which a following vehicle cuts in front of the vehicle from a left side or a right side.

6. A drive recorder that is mounted on a vehicle and is configured to communicate with a management apparatus, the drive recorder comprising:
one or more first processors; and
a first memory coupled to the one or more first processors and storing program instructions that when executed by the one or more first processors cause the one or more first processors to at least:
capture a periphery of the vehicle, and generate an image;
store the image that is generated;
associate the image with any of a plurality of danger patterns set in advance by analyzing the image that is generated;
transmit vehicle information including a danger pattern associated with the image and identification information of the vehicle to the management apparatus;
acquire a transmission instruction specifying the danger pattern from the management apparatus; and
transmit the image that is stored and is associated with the danger pattern that is specified to the management apparatus.

7. The drive recorder according to claim 6, wherein:
the first memory coupled to the one or more first processors and storing program instructions that when executed by the one or more first processors further cause the one or more first processors to at least:
acquire vehicle state information representing a state of the vehicle: and
the vehicle information further includes the vehicle state information.

8. An image storage system comprising:
the drive recorder according to claim 6; and
the management apparatus,
wherein:
the management apparatus includes:
one or more second processors; and
a second memory coupled to the one or more second processors and storing program instructions that when executed by the one or more second processors cause the one or more second processors to at least:
store the vehicle information that is transmitted;
transmit the transmission instruction; and
store the image that is transmitted.

9. The image storage system according to claim 8, wherein:
the second memory coupled to the one or more second processors and storing program instructions that when executed by the one or more second processors further cause the one or more second processors to at least:
display the vehicle information;
acquire a transmission instruction content; and
generate the transmission instruction based on the transmission instruction content that is acquired.
